(19) United States
(12) Patent Application Publication
(10) Pub. No.: US 2008/0062070 A1
(43) Pub. Date: Mar. 13, 2008

(54) LED BRIGHTNESS COMPENSATION SYSTEM AND METHOD

(75) Inventors: Leonard De Oto, Springfield, OH (US); Thomas E. Clary, Springfield, OH (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(73) Assignee: Honeywell International Inc., Morristown, NJ (US)

(21) Appl. No.: 11/531,596

(22) Filed: Sep. 13, 2006

(51) Int. Cl. G09G 3/14

(52) U.S. Cl. 345/46

(57) ABSTRACT

LED brightness compensation system and method to account for aging and/or temperature effects on LED brightness. The system includes one or more LEDs and a circuit coupled to the LEDs to maintain substantially constant LED brightness based on determined operating characteristics of the LEDs. The circuit includes an LED brightness controller for controlling the current running through the LEDs and a brightness compensation controller for directing the LED brightness controller to compensate for aging and/or temperature. The method includes: storing adjustment information in a memory unit; energizing one or more LEDs with an electric current; accumulating the operating time; sensing the operating temperature of the LEDs; and adjusting the current supplied to the LEDs based on the stored adjustment information, the accumulated time the LEDs have been energized, and the operating temperature of the LEDs.

### BACKGROUND OF THE INVENTION

The brightness of Light Emitting Diodes (LEDs) in LED based lights decreases over their operating time. The operating temperature of the LEDs also affects LED brightness. In many systems, it is desirable to maintain a relatively constant LED brightness level. Some previous attempts at compensating for factors affecting LED brightness have relied on a simple linear model for LED brightness changes over time. Additionally, they have not accounted for temperature effects on LED brightness. Other previous attempts at compensating for LED brightness changes involve adjusting the light output to be greater than the minimum required when the LEDs are first used and deactivating the LEDs after a calculated period of time when the light output has been predicted to have decreased to below an acceptable level. This has the unfortunate side effect of having to provide higher energy levels to the LEDs, thus increasing their operating temperature, increasing the brightness decay rate, and shortening the operating life of the LEDs. Still other previous attempts have used optical brightness sensors to provide feedback in maintaining constant LED brightness. However, using optical brightness sensors is disadvantageous because it is a complex and expensive solution. Accordingly, there is a need for an LED brightness compensation system and method that more accurately reflects the characteristics of LED brightness changes than a simple linear model and that does not involve the expense and complexity of using optical brightness sensing. There is a further need for an LED brightness compensation system and method to account for the effects of temperature changes on LED brightness.

### SUMMARY OF THE INVENTION

The present invention provides an LED brightness compensation system and method that accounts for the effects of operating time and/or temperature on LED brightness. An example system includes one or more LEDs and a circuit electrically coupled to the LEDs for maintaining a substantially constant brightness of the LEDs over an extended period of time based on previously determined operating characteristics of the LEDs.

In one aspect of the invention, the circuit includes an LED brightness controller for controlling the current running through the LEDs and a brightness compensation controller for directing the LED brightness controller to compensate for LED brightness changes over time. In another aspect of the invention, the brightness compensation controller includes: a memory unit for storing adjustment information to compensate for factors affecting LED brightness; a time keeping component for accumulating the period of time the LEDs have been energized; and a logic component for determining an adjustment output based on the stored adjustment information and the accumulated period of time the LEDs have been energized. In other embodiments, these components and/or functions are included in a microcontroller.

In an additional aspect of the invention, the circuit includes a configuration interface that allows changes to be made to the adjustment information stored in the memory unit. In a still further aspect of the invention, the circuit includes a temperature sensor for producing a signal related to the operating temperature of the LEDs, and the brightness compensation controller includes an input for the signal produced by the temperature sensor.

In other aspects, the invention includes a method for adjusting a current through one or more Light Emitting Diodes (LEDs) to compensate for factors affecting LED brightness. The method includes: storing adjustment information to compensate for factors affecting LED brightness in a memory unit; energizing one or more LEDs with an electric current; accumulating the time the LEDs have been energized; sensing the operating temperature of the LEDs; and adjusting the current supplied to the LEDs based on the stored adjustment information, the accumulated time the LEDs have been energized, and the operating temperature. In some embodiments, the current is adjusted by changing the level of a constantly applied current. In other embodiments, the current is adjusted by pulse width modulating (PWM) a pre-determined current level.

In additional aspects of the invention, the method includes testing a first test LED to determine the current required to keep the first test LED at a relatively constant brightness over an extended period of time as a function of time to determine adjustment information. In other aspects of the invention, the method also includes testing a second test LED to determine the current required to keep the second test LED at a relatively constant brightness for operation at different operating temperatures as a function of temperature.

As will be readily appreciated from the foregoing summary, the invention provides an LED brightness compensation system and method that more accurately reflects the characteristics of LED brightness changes than a simple linear model and that does not involve the expense and complexity of using optical brightness sensing. The invention also provides an LED brightness compensation system and method that accounts for the effects of temperature changes on LED brightness.

### BRIEF DESCRIPTION OF THE DRAWINGS

Preferred and alternative embodiments of the present invention are described in detail below with reference to the following drawings:

FIG. 1A is a diagram of an LED brightness compensation system in accordance with an embodiment of the invention;

FIG. 1B is a diagram of an LED brightness compensation system that includes operating temperature compensation in accordance with an embodiment of the invention;

FIG. 2 is a diagram showing additional detail for an example embodiment of a brightness compensation controller shown in FIG. 1B;

FIG. 3A is a chart showing LED energy adjustment data for the effect of operating time on LED brightness in accordance with an example embodiment of the invention;

FIG. 3B is a table showing LED energy adjustment data corresponding to the chart shown in FIG. 3A that is used in configuring an example embodiment of the invention;

FIG. 4A is a chart showing the LED energy adjustment data for the effect of operating temperature on LED aging in accordance with an example embodiment of the invention;

FIG. 4B is a table showing LED energy adjustment data corresponding to the chart shown in FIG. 4A that is used in configuring an example embodiment of the invention;

FIG. 5A is a chart showing LED energy adjustment data for the instantaneous effect of operating temperature on LED brightness in accordance with an example embodiment of the invention;

FIG. 5B is a table showing LED energy adjustment data corresponding to the chart shown in FIG. 5A that is used in configuring an example embodiment of the invention; and

FIG. 6 is a flowchart of a method of compensating for the effects of operating time and operating temperature on LED brightness in accordance with an embodiment of the invention.

### DETAILED DESCRIPTION OF THE PREFERRED EMBODIMENT

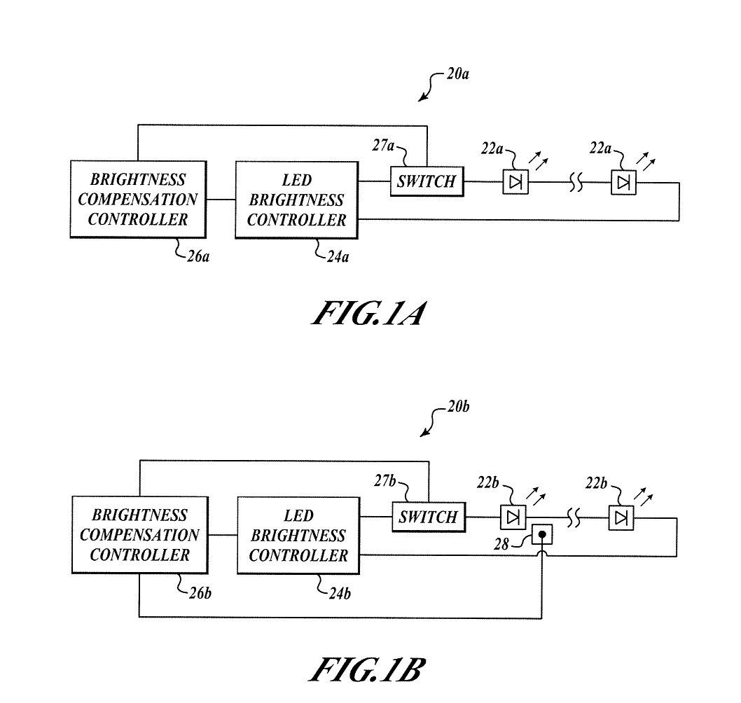

FIG. 1A is a diagram of a Light Emitting Diode (LED) brightness compensation system 20a in accordance with an embodiment of the invention. The LED brightness compensation system 20a includes one or more LEDs 22a. The LED brightness compensation system 20a also includes an LED brightness controller 24a electrically connected to the one or more LEDs 22a for controlling the energy supplied to the one or more LEDs 22a based on a signal received from a brightness compensation controller 26a. In one embodiment, a switch 27a is connected between the LED brightness controller 24a and the anode of the first LED of the one or more LEDs 22a. The switch 27a is also connected to the brightness compensation controller 26a to provide ON/OFF state information for the one or more LEDs 22a. However, in other embodiments, the switch 27a is located in a different location and/or the brightness controller 26a receives ON/OFF state information for the one or more LEDs 22a in a different manner. The brightness compensation system 20a is also connected to a power supply (not shown). The brightness compensation controller 26a is configured to send the signal to the LED brightness controller 24a based on the accumulated operating time of the one or more LEDs 22a which is determined by monitoring the ON/OFF state information provided by the switch 27a in this example. In this example embodiment, the signal is a digital signal, but in other embodiments the signal is an analog signal. As examples, the brightness controller 24a uses pulse width modulation in some embodiments and direct current control in other embodiments of the invention. In other embodiments of the invention, the brightness compensation controller 26a and the LED brightness controller 24a are combined.

FIG. 1B is a diagram of an LED brightness compensation system 20b that is similar to the system 20a, but that also includes operating temperature compensation in accordance with an embodiment of the invention. In addition to having an LED brightness controller 24b in common with the system 20a, the LED brightness compensation system 20b also includes a temperature sensor 28 for sensing the operating temperature of one or more LEDs 22b. The temperature sensor 28 is in signal communication with a brightness compensation controller 26b, which is similar to the brightness compensation controller 26a except that it is also configured to send a signal to control the LED brightness controller 24b based on the temperature sensed by the temperature sensor 28 in addition to the accumulated operating time of the one or more LEDs 22b. In one embodiment, a switch 27b is connected between the LED brightness controller 24b and the anode of the first LED of the one or more LEDs 22b. The switch 27b is also connected to the brightness compensation controller 26b to provide ON/OFF state information for the one or more LEDs 22b. However, in other embodiments, the switch 27b is located in a different location and/or the brightness controller 26b receives ON/OFF state information for the one or more LEDs 22b in a different manner. The brightness compensation system 20b is also connected to a power supply (not shown). As for the system 20a, in other embodiments of the invention, the brightness compensation controller 26b and the LED brightness controller 24b are combined. In one embodiment, the LED brightness compensation system 20b is used on an aircraft in association with exterior and/or interior LED lighting.

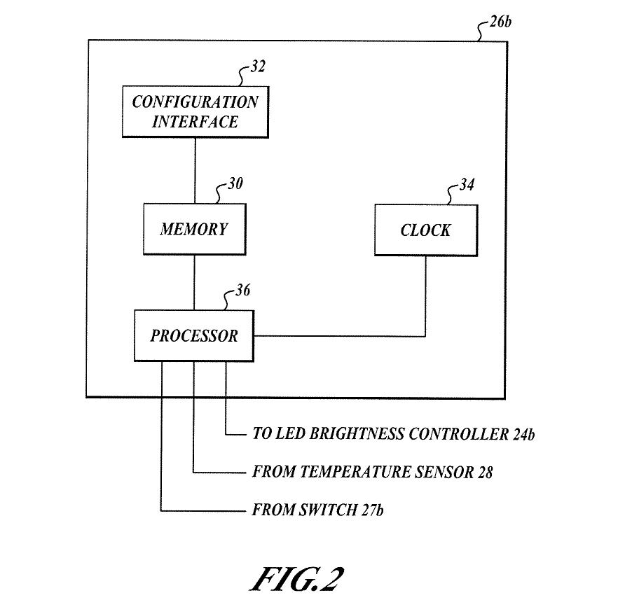

FIG. 2 is a diagram showing additional detail for an example embodiment of the brightness compensation controller 26b shown in FIG. 1B. The brightness compensation controller 26b includes a non-volatile memory unit 30 in data communication with a configuration interface 32 and a processor 36. The processor is in signal communication with the LED brightness controller 24b, the switch 27b, and the temperature sensor 28. The brightness compensation controller 26b also includes a clock 34 in communication with the processor 36. The processor 36 includes volatile memory in some embodiments for temporary storage. Other embodiments also include a volatile memory unit (not shown) external to the processor 36. The brightness compensation controller 26b is also connected to a power supply (not shown). In other embodiments, a programmable logic device having the required functionality is used. In still other embodiments, individual components are used to implement the brightness compensation controller 26b. Although the configuration interface 32 is shown directly connected to the memory unit 30 in this embodiment, the configuration interface 32 is connected to the processor 36 in other embodiments such that the processor 36 can coordinate storage of information in the memory unit 30.

The configuration interface 32 is used to store correction factors (adjustment information) in the memory unit 30 based on previously conducted testing and/or simulation of one or more LEDs similar to the one or more LEDs 22b being used in the system 20b. In some embodiments, the configuration interface 32 may be used to update the stored adjustment information as desired if improved LED data becomes available. In some embodiments, the configuration interface 32 may also be used to update algorithm control information stored in the memory unit 30 as well to be used by the processor 36 to change LED brightness models employed in the adjustment algorithm. As an example, the algorithm control information contains instructions for interpolating between stored adjustment information values in some embodiments. For example, the instructions contain information for a linear interpolation and/or a curve-fitting algorithm to be used by the processor 36. The processor 36 generates a control signal that is presented at an output connected to the LED brightness controller 24b. The control signal may be an analog voltage, a digital pulse width modulated signal, or a digital data signal, for example. The processor 36 generates the control signal based on the correction factors stored in the memory unit 30, the signal from the temperature sensor 28, and the signal from the clock 34. In some embodiments, the clock 34 accumulates the operating time of the one or more LEDs 22b and presents the accumulated time to the processor 36. In other embodiments, the clock 34 presents a signal containing time information without regard to the operating time of the one or more LEDs 22b and the processor 36 calculates and stores the accumulated operating time of the one or more LEDs 22b based on the time information contained in the signal from the clock 34 and ON/OFF state information for the one or more LEDs 22b received from the switch 27b.

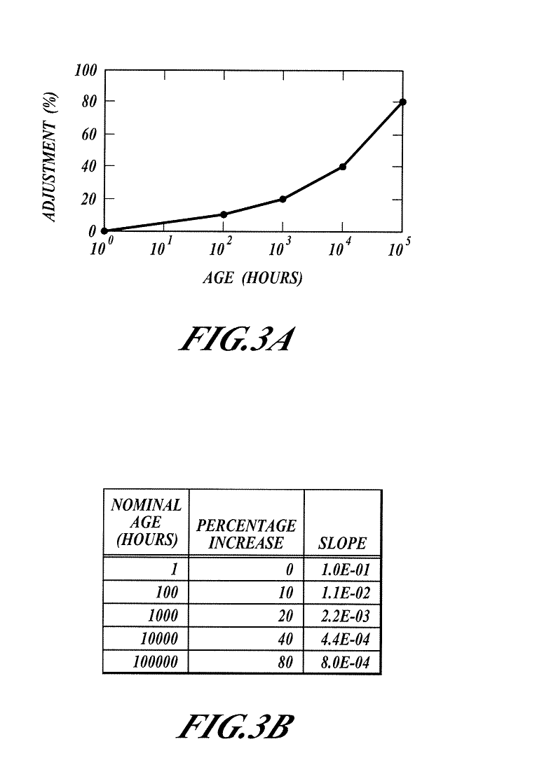

FIG. 3A is an example compensation chart showing LED energy adjustment data for the effect of operating time on LED brightness in accordance with an example embodiment of the invention. The values shown in the compensation chart would be determined by characterizing the response of a specific type of LED to be used. As an example, an LED could be characterized by placing the LED in a testing system that measures the change in energy required to be supplied to the LED to maintain constant brightness over the course of many hours of operation. FIG. 3B is a table showing LED energy adjustment data corresponding to the chart shown in FIG. 3A that is used in configuring an example embodiment of the invention. This information is loaded using the configuration interface 32 and stored in the non-volatile memory unit 30.

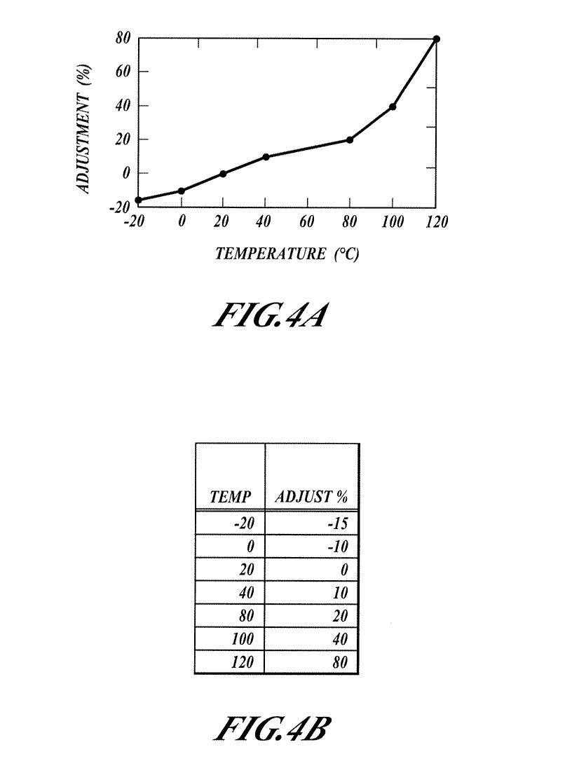

FIG. 4A is a chart showing the LED energy adjustment data for the effect of operating temperature on LED aging in accordance with an example embodiment of the invention. The values in the chart indicate age acceleration and deceleration factors as they relate to operating temperature. For example, at 20 degrees Celsius, the aging adjustment is zero resulting in one hour of adjusted aging for every actual clock hour of operation. However, at 40 degrees Celsius, the aging will be 10% faster resulting in 66 minutes of adjusted aging for every actual clock hour of operation. FIG. 4B is a table showing LED energy adjustment data corresponding to the chart shown in FIG. 4A that is used in configuring an example embodiment of the invention. This information is loaded using the configuration interface 32 and stored in the non-volatile memory unit 30.

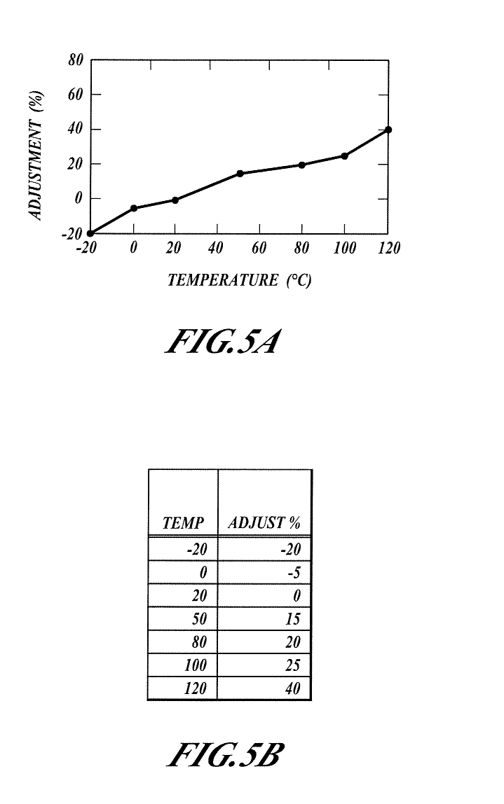

FIG. 5A is a chart showing LED energy adjustment data for the instantaneous effect of operating temperature on LED brightness in accordance with an example embodiment of the invention. The values in the chart indicate immediate adjustments to the energy supplied to the LEDs to adjust for temperature dependent brightness changes. In an example embodiment, the operating temperature is monitored approximately once per second and adjustments are made accordingly. These adjustments help maintain constant LED brightness levels because LEDs get brighter at lower temperatures given the same energy input. Reducing current to LEDs at lower temperatures and increasing current at higher temperatures is useful to maintain constant LED brightness. FIG. 5B is a table showing LED energy adjustment data corresponding to the chart shown in FIG. 5A that is used in configuring an example embodiment of the invention. Based on this example table, at −20 degrees Celsius, a 20% reduction in energy would produce the same brightness that would exist at 20 degrees Celsius with constant energy. The information in the table is loaded using the configuration interface 32 and stored in the non-volatile memory unit 30.

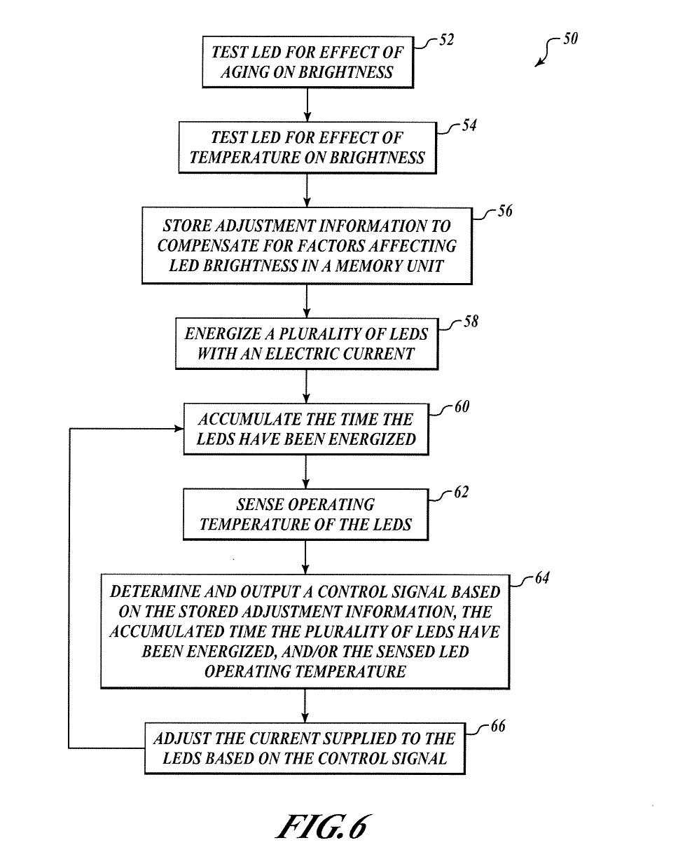

FIG. 6 is a flowchart of a method 50 of compensating for the effects of operating time and operating temperature on LED brightness in accordance with an embodiment of the invention. The method 50 begins at a block 52 where an LED with characteristics similar to those of the one or more LEDs 22b is tested for the effect of operating time (aging) on brightness to obtain adjustment information correlated with operating time. Next, at a block 54 an LED with characteristics similar to the one or more LEDs 22b is tested for the effect of operating temperature on brightness to obtain adjustment information correlated with operating temperature. This testing includes the instantaneous effect of operating temperature on LED brightness as well as the effect of operating temperature on the rate of LED aging in some embodiments. Then, at a block 56, the adjustment information correlated with operating time and/or temperature obtained in the blocks 52 and/or 54 is stored in a memory unit. Next, at a block 58, one or more LEDs are energized with an electric current. Then, at a block 60, the time the one or more LEDs have been energized is accumulated. This accumulating of energized time continues throughout the following steps of the method 50. In this example embodiment, energized time is accumulated once per second. However, in other embodiments, time is accumulated at different rates such as once per minute, once per hour, once per millisecond, or at some other frequency for example. Next, at a block 62, the operating temperature of the one or more LEDs is sensed. In this example embodiment, the operating temperature is sensed approximately once per second. However, in other embodiments the operating temperature is sensed at other frequencies. Then, at a block 64, a control signal is determined and output based on the stored adjustment information, the accumulated time the one or more LEDs have been energized, and/or the sensed LED operating temperature. Following this, at a block 66, the current supplied to the one or more LEDs is adjusted based on the control signal. In an example embodiment, the current is adjusted by changing the level of a constantly applied current. However, in other embodiments, the current is adjusted by pulse width modulation of a pre-determined current level. The method 50 then loops back to the block 60.

While the preferred embodiment of the invention has been illustrated and described, as noted above, many changes can be made without departing from the spirit and scope of the invention. For example, the brightness compensation controller may be implemented using a microcontroller, a programmable logic device, or by using individual components. Additionally, different algorithms may be used in the brightness compensation controller to determine control signals for adjustment factors that occur between stored data values. For example, interpolations may be made using a linear fit based on the two closest data values, a curve could be fit using a commonly known statistical curve fitting formula based on the stored data values, or a constant correction may be applied in a step-wise fashion until the next data value is reached. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A Light Emitting Diode (LED) system comprising:
one or more LEDs; and
a circuit electrically coupled to the one or more LEDs for maintaining a substantially constant brightness of the one or more LEDs over an extended period of time based on previously determined operating characteristics of the one or more LEDs.

2. The system of claim 1, wherein the circuit comprises:
an LED brightness controller for controlling the current running through the one or more LEDs; and
a brightness compensation controller for directing the LED brightness controller to compensate for LED brightness changes over time.

3. The system of claim 2, wherein the brightness compensation controller comprises:
a memory unit for storing adjustment information to compensate for factors affecting LED brightness;
a time keeping component for accumulating the period of time the one or more LEDs have been energized; and
a logic component for determining an adjustment output based on the stored adjustment information and the accumulated period of time the one or more LEDs have been energized.

4. The system of claim 3, further comprising a configuration interface that allows changes to be made to the adjustment information stored in the memory unit.

5. The system of claim 3, further comprising a temperature sensor for producing a signal related to the operating temperature of the one or more LEDs, and sending the produced signal to the brightness compensation controller.

6. The system of claim 3, wherein the memory unit stores adjustment information related to the effect accumulated time being energized has on the LED brightness.

7. The system of claim 6, wherein the memory unit also stores adjustment information related to the effect of temperature changes on the LED brightness.

8. The system of claim 7, wherein the adjustment information related to the effect of temperature changes on the LED brightness includes adjustment information for the instantaneous effect of operating temperature on LED brightness.

9. The system of claim 7, wherein the adjustment information related to the effect of temperature changes on the LED brightness includes adjustment information for the effect of operating temperature on LED aging.

10. The system of claim 3, wherein the brightness compensation controller includes a microcontroller.

11. The system of claim 3, wherein the brightness compensation controller includes a programmable logic device.

12. The system of claim 3, wherein the one or more LEDs are located on an aircraft.

13. A method for adjusting a current through one or more Light Emitting Diodes (LEDs) to compensate for factors affecting LED brightness, the method comprising:
storing adjustment information to compensate for factors affecting LED brightness in a memory unit;
energizing one or more LEDs with an electric current;
accumulating the time the one or more LEDs have been energized; and
adjusting the current supplied to the one or more LEDs based on the stored adjustment information and the accumulated time the one or more LEDs have been energized.

14. The method of claim 13, further comprising sensing the operating temperature of the one or more LEDs, wherein adjusting the current is also based on the sensed operating temperature.

15. The method of claim 14, wherein adjusting the current based on the sensed operating temperature includes making an adjustment for the instantaneous effect of operating temperature on LED brightness.

16. The method of claim 14, wherein adjusting the current based on the sensed operating temperature includes making an adjustment for the effect of operating temperature on LED aging.

17. The method of claim 14, wherein adjusting the current includes adjusting a constantly applied current.

18. The method of claim 14, wherein adjusting the current includes pulse width modulating a pre-determined current level.

19. The method of claim 13, further comprising testing a first test LED to determine the current required to keep the first test LED at a relatively constant brightness over an extended period of time as a function of time, the testing providing adjustment information and the testing being conducted before the storing adjustment information step.

20. The method of claim 19, further comprising testing a second test LED to determine the current required to keep the second test LED at a relatively constant brightness for operation at different operating temperatures as a function of temperature, the testing providing adjustment information and the testing being conducted before the storing adjustment information step.
